(19) United States
(12) Patent Application Publication
(10) Pub. No.: US 2023/0339570 A1
(43) Pub. Date: Oct. 26, 2023

(54) PEDAL GRIP PAD AND ASSOCIATED KIT, PEDAL AND SHOE

(71) Applicant: Luke Simmons, Maroubra (AU)

(72) Inventor: Luke Simmons, Maroubra (AU)

(21) Appl. No.: 18/136,487

(22) Filed: Apr. 19, 2023

(30) Foreign Application Priority Data
Apr. 22, 2022 (AU) 2022901075

(51) Int. Cl. B62M 3/08; A43B 5/14; A43C 15/16

(52) U.S. Cl. CPC B62M 3/086; A43B 5/14; A43C 15/162

(57) ABSTRACT

A pedal and shoe system includes a shoe having a sole. The sole includes a plurality of projections extending downward from the sole's surface. The petal includes a platform including a planar top surface for receiving the sole and a plurality of recesses, wherein each recess is equispaced from one another and distributed throughout the top surface of the pedal platform. The plurality of recesses extending downwardly from the planer top surface and being shaped and sized to removably receive the plurality of projections.

### CROSS-REFERENCE TO RELATED APPLICATIONS

The present invention claims priority to Australian patent application 2022901075 filed Apr, 22, 2022.

### BACKGROUND OF THE INVENTION

### 1. Field of the Invention

The present patent specification discloses a pedal grip pad and an associated kit, pedal and shoe.

### 2. Description of Related Art

FIG. 1 shows a prior art bicycle pedal 2 having a pair of faces or platforms 4 for receiving a cyclist's shoe during cycling. It is known to provide the platforms 4 with upwardly extending spikes 6 configured to temporarily engage the sole of the cyclist's shoes during cycling so as to increase a grip between the cyclist's shoes and the pedals 2.

Generally, the sharper the spikes, the greater the grip or purchase. However, the spikes 6 also pose a safety risk, particularly when a cyclist loses their footing on the pedals 2 and/or otherwise loses control of the bicycle, in which case the spikes 6 can cut the cyclist's legs. Even when not in use, (e.g., the cyclist could simply be walking the bicycle around), the sharp spikes 6 still pose a safety risk if the cyclist accidentally makes contact with the pedals 2.

Consequently, there is a need to address the concerns above and provide a safer and useful alternative.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, a pedal grip pad configured for releasably receiving projections extending downwardly from a sole of a user's shoe is provided, the pedal grip pad comprising a bottom surface configured for engagement with one of the two shoe-receiving faces of a pedal; and, a platform for engaging the user's shoe, the platform comprising a planar top surface for receiving the sole of the user's shoe and a plurality of recesses that are equispaced from one another and distributed throughout the top surface of the platform, wherein the each recess of the plurality of recesses extends downwardly from the top surface, and is shaped and sized to receive a respective projection of the user's shoe.

In one embodiment, each recess of the plurality of recesses comprises a floor at a depth between the top surface of the platform and the bottom surface of the pedal grip pad. In another embodiment, each respective floor of each recess lies in a plane that defines an intermediate surface configured to engage respective ends of the projections when the projections are inserted into the plurality of recesses. In one embodiment, each recess comprises one or more sidewalls configured to engage against a length of a respective projection of the user's shoe. In one embodiment, the plurality of recesses are generally distributed in a waffle pattern. In yet another embodiment, the pedal grip pad is provided in a kit as a pair of pedal grip pads and a pedal, where the pair of pedal grip pads are securable to the pedal.

In another aspect of the invention, a pedal comprising platforms for receiving a user's shoe having projections extending downwardly from a sole thereof is provided, each platform comprising a planar top surface for receiving the sole of the user's shoe; and a plurality of recesses, wherein each recess is equispaced from one another and distributed throughout the top surface of the platform, the plurality of recesses extending downwardly from the top surface and being shaped and sized to receive a respective projection of the user's shoe.

In one embodiment, each recess comprises a floor at a depth below the top surface of the platform, the respective floors of each recess lying in a plane that defines an intermediate surface configured to engage respective ends of the projections when the projections are inserted into the plurality of recesses. In one embodiment, each recess comprises one or more sidewalls configured to engage against a length of a respective projection of the user's shoe. In another embodiment, the plurality of recesses are generally distributed in a waffle pattern.

In yet another aspect of the invention, a pedal and shoe system is provided, comprising a shoe having a sole, the shoe comprising a plurality of projections extending downwardly from the sole; a pedal platform having a planar top surface for receiving the sole and a plurality of recesses, wherein each recess is equispaced from one another and distributed throughout the top surface of the pedal platform; and, the plurality of recesses extending downwardly from the planer top surface and being shaped and sized to removably receive the plurality of projections.

In one embodiment, the plurality of projections is comprised of rigid spikes. In one embodiment, the projections are evenly distributed across the sole of the shoe.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a top perspective view of bicycle pedal of the prior art;

FIG. 2 is a top perspective view of a bicycle pedal of the prior art;

FIG. 3 is a top perspective view of a pedal grip pad on a bicycle pedal according to an embodiment of the present invention;.

FIG. 4A is a top perspective view of the pedal grip pad according to an embodiment of the present invention;

FIG. 4B is a close-up cross-sectional top perspective view of a recess of the grip pad of FIG. 4A;

FIG. 5A is a top view of the grip pad of FIG. 4A;

FIG. 5B is a bottom view of the grip pad of FIG. 4A; and,

FIG. 6 is a bottom view of a shoe configured for engagement with examples of the presently disclosed grip pad and bicycle pedal.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide pedal grip pad and associated kit, pedal and shoe.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

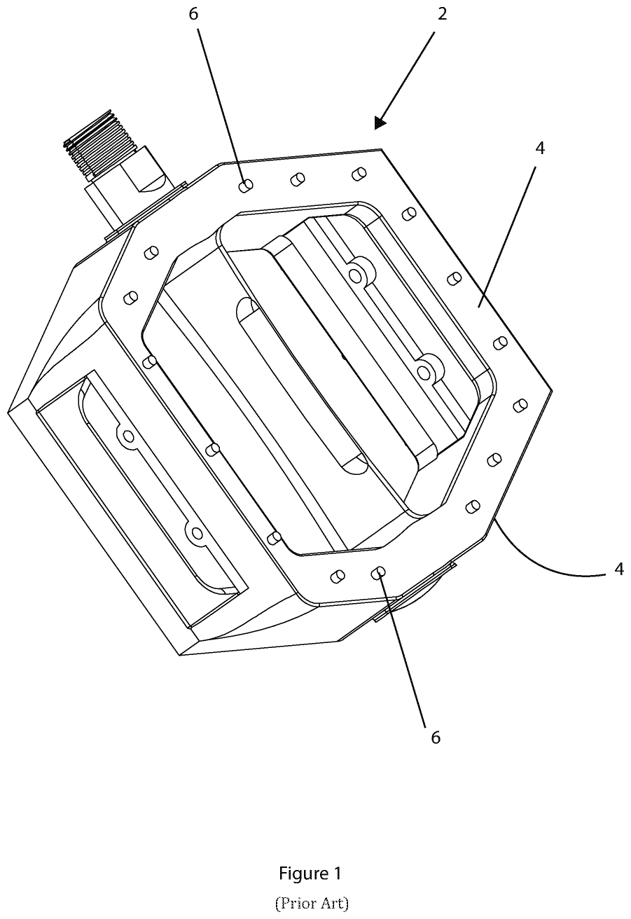

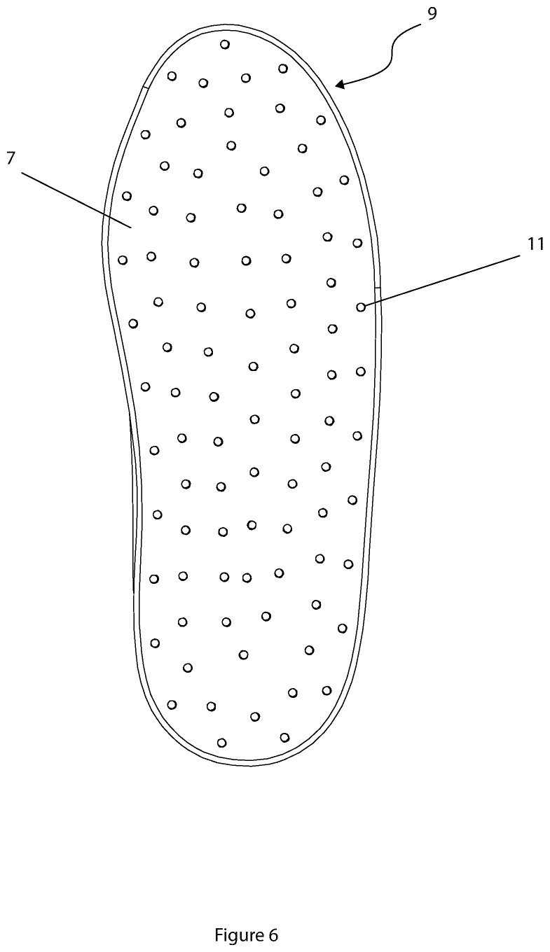

Referring to FIG. 1, it is known to increase the grip or purchase between a cyclist's shoe and a bicycle pedal 2 by providing the pedal 2 with a plurality of upwardly extending projections or spikes 6. However, these spikes 6 pose a potential safety risk and can inadvertently cut the cyclist during use. The principle underlying the present invention relies on inverting the spike and shoe arrangement. In particular, rather than providing spikes on the pedal, spikes are provided at the bottom of the cyclist's shoes. For example, with reference to FIG. 6, the sole 7 of the depicted shoe 9 is provided with a plurality of generally evenly distributed and downwardly extending projections, such as relatively sharp and rigid spikes 11. Meanwhile, the shoe-receiving faces of the bicycle pedal may be provided with a platform or grip pad-type arrangement configured to receive the spikes of the cyclist's shoes. In this way, increased grip/purchase between the cyclist's shoes 9 and the pedals can be achieved, however since the spikes 11 are now in the bottom of the cyclist's shoes 9 rather than on the exposed faces of the pedals, the pedals no longer pose a similar safety risk to the cyclist.

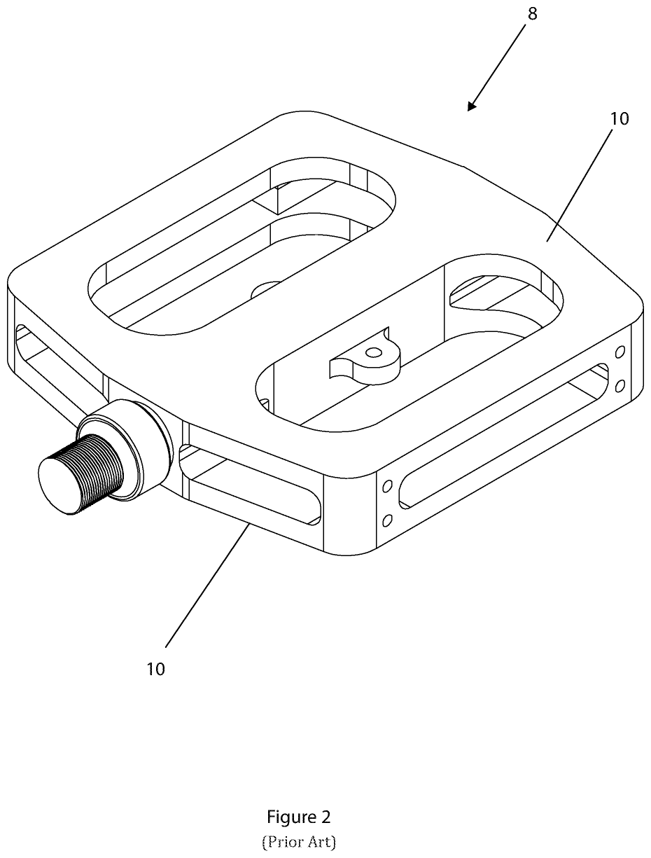

FIG. 2 shows an example of a prior art bicycle pedal 8 comprising a pair of shoe-receiving faces 10 typically provided with spikes. Advantageously, the present invention is configured to be used with this typical pedal provided.

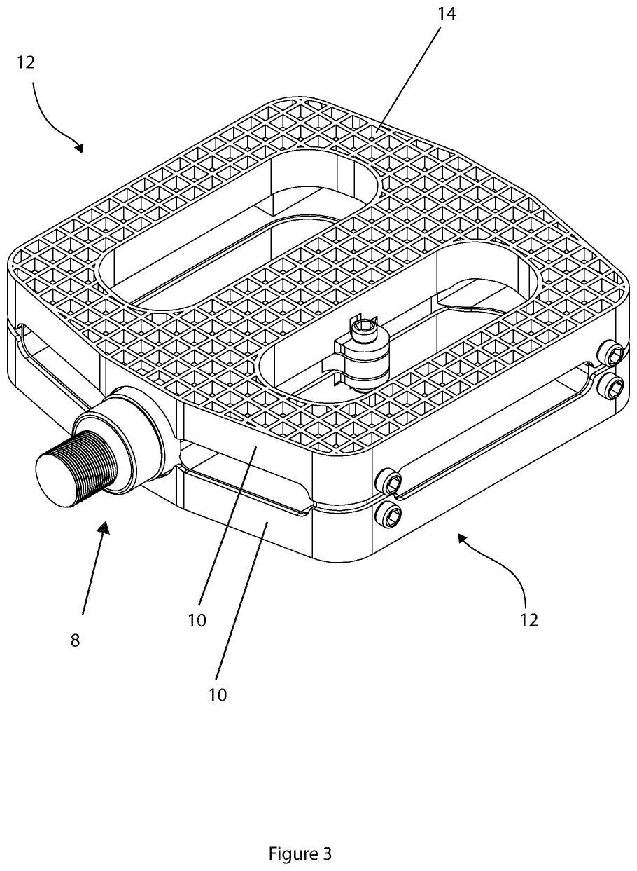

Referring now to FIG. 3, a bicycle pedal 8, similar to the pedal shown in FIG. 2 is illustrated, wherein each of the shoe-receiving faces 10 is now covered by a grip pad 12. In one embodiment, the grip pads 12 are configured with a plurality of recesses 14 shaped and sized to receive the downwardly extending projections of the cyclist's shoes. This will be described in more details below. It should be noted, that the grip pad 12 is depicted in the Figures such that its general profile and shape aligns with the pedal 8 of FIG. 2, though it will be appreciated that the shape and profile (i.e., the footprint) of the grip pad 12 can vary to suit the shape and configuration of bicycle pedal it is to be used with. Simply put, the shape and profile may vary without departing from the scope and spirit of the invention.

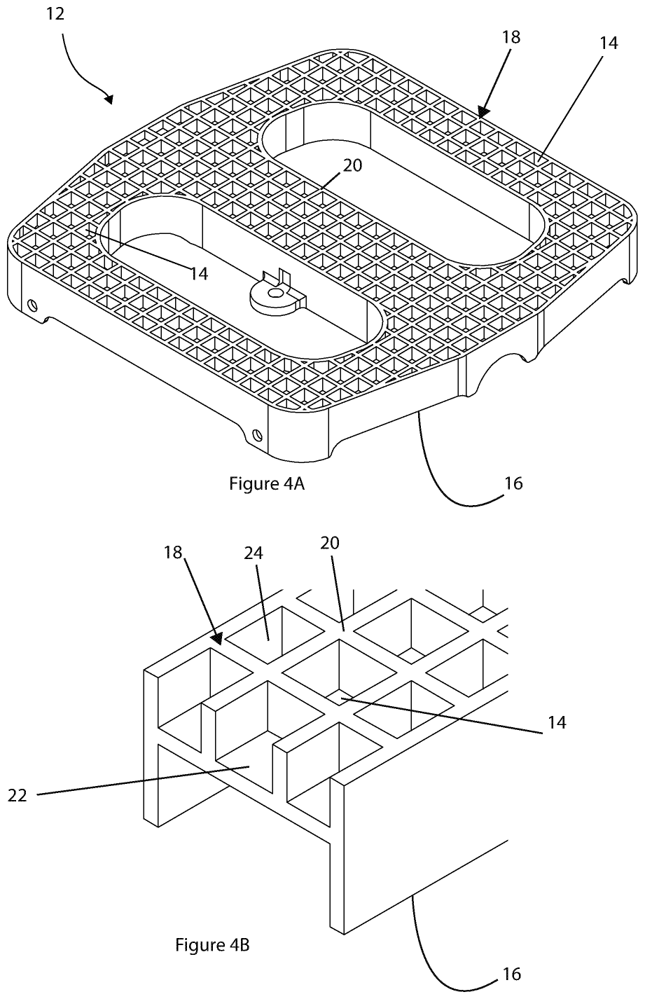

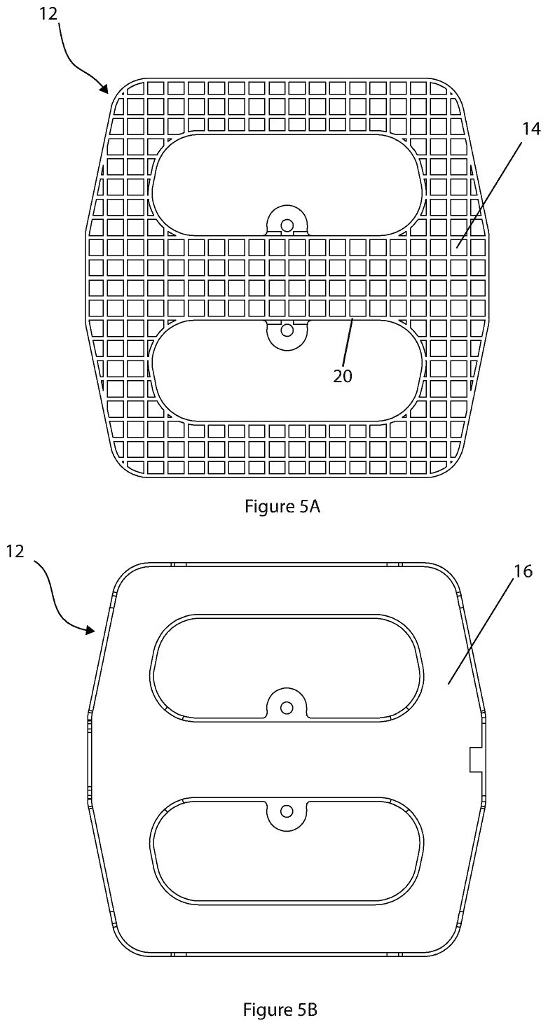

Referring now to FIG. 4A, the grip pad 12 is illustrated. In one embodiment, the grip pad comprises a substantially planar bottom surface 16 (best seen FIG. 5B) configured to be secured to one of the two shoe-receiving faces 10 of the bicycle pedal 8. For example, the bottom surface 16 of the grip pad 12 may be fixed or sufficiently bonded or otherwise adhered to the pedal 8 such that the grip pad 12 will not readily be dislodged from or be displaced relative to the pedal 8 during use. However, in other embodiments, the grip pad 12 may be selectively engageable with the pedal 8 such that the grip pad 12 can be applied to and/or removed from the pedal 8 as desired. In yet other embodiments, the grip pad 12 is relatively fixed to the pedal 8 (e.g., via fixing means such as bolts and the like).

Referring now to FIGS. 4A and 4B, the grip pad 12 further comprises an upper platform 18 arranged for receiving the cyclist's shoe. In particular, the platform 18 includes a top surface 20 that lies in a first plane and is configured to directly receive the bottom face of the sole of the cyclist's shoe, i.e., even if one were to wear shoes without downwardly extending spikes, the sole of such a shoe would be received on the top surface 20 of the platform 18.

In some embodiments, the platform 18 also comprises a plurality of recesses 14 distributed throughout the top surface 20. In the depicted embodiment, the recesses 14 are generally equispaced from one another and distributed in a waffle or crosshatch-like pattern. For example, many of the recesses 14 in the Figures have a square-shaped footprint, though some recesses 14 are different in shape and size so as to fit within the footprint and perimeter of the grip pad 12. In one example, the recesses 14 may generally have a square perimeter having side lengths of about 5 mm. It should be understood, other shapes and associated dimensions are within the scope of the present specification.

In one embodiment, each recess 14 extends downwardly from the top surface 20 of the platform 18. In particular, each recess 14 extends downwardly in a direction that is generally normal to the plane of the top surface 20. Moreover, each recess 14 extends to a depth that is below the top surface 20 of the platform 18 and above the bottom surface 16 of the grip pad 12. In one embodiment, at the depth of each recess 14 is a landing or floor 22 that closes the recess 14. In one embodiment, the floors 22 of all the respective recesses 14 together lie on a second plane which defines an intermediate surface for receipt of the tips or ends of the respective downwardly extending projections of the shoe. In one example, the recesses 14 may have a depth of about 1.5 mm. In such an embodiment, the total thickness/height of the grip pad may be about 3 mm. It should be understood, other dimensions, thicknesses, depths etc. are within the scope of the present specification. In yet another embodiment, the recesses 14 may be substantially open and lack respective floors (in which case the depth of a recess 14 would be equivalent to the height of the grip pad 12).

In one embodiment, the recesses 14 are also defined by one or more sidewalls 24 that are configured, in use, to engage against a length of a respective spike during use. In particular, contact between the sidewalls 24 and the spikes can provide increased grip/purchase between the cyclist's shoes and the pedal, particularly during a forward and rearward circular motion of the cyclist's feet.

In some embodiments, the grip pad 12 may be relatively rigid and could be made from a material such as thermoplastic polyurethane. However, other materials, including other plastics and elastomers are considered may be provided and within the scope of the present specification.

While the above description and the Figures generally relate to bicycle pedals, the teachings of the present specification are similarly applicable to other foot-operated pedals and associated devices, including, for example, tricycles, pedal-operated boats, exercise bicycles and the like.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention. For example, while the above description primarily relates to a grip pad 12 that can be fitted to an existing bicycle pedal 8, it should be appreciated that the teachings herein would similarly apply to bicycle pedals pre-formed with such grip pad-like features. For example, a bicycle pedal whose shoe-receiving faces are pre-formed with projection-receiving recesses is within the scope of the present specification. In other words, a bicycle pedal integrally formed with the presently disclosed grip pad-like features is within the scope of the present specification.

While the Figures merely depict an example of how the recesses may be shaped and arranged, the configuration and arrangement of recesses may of course vary to suit the cyclist, their shoe and/or the downwardly extending projections thereof. For example, while the recesses extend generally downwardly in a direction that is perpendicular to the top surface of the grip pad, it is envisaged that the recesses may extend downwardly on an angle; e.g., the recesses might have respective longitudinal axes that are angled rearwardly relative to the top surface of the grip pad.

The downwardly extending projections of the shoe may vary in size, shape and distribution to suit the recess configuration of the grip pads or bicycle pedal platforms. Preferably, the projections are not simply concentrated in one area of the shoe's sole and absent from another; instead, the projections can be equispaced and evenly distributed across a substantial portion if not the entire sole. In this way, a cyclist need not strive for ideal placement of their shoe on a bicycle pedal; instead, even if a cyclist only achieves less than optimal engagement between the shoe and the pedal (e.g., only a front or rear of their shoe lands on the grip pad), the shoe will still be able to engage the grip pad and bicycle pedal due to the sole of the shoe being substantially covered in the recess-engaging downwardly extending projections.

It should further be noted that throughout the entire disclosure, the labels such as left, right, front, back, top, bottom, forward, reverse, clockwise, counterclockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and etc. members throughout the disclosure (and in particular, claims) are not used to show a serial or numerical limitation but instead are used to distinguish or identify the various members of the group.

What is claimed is:

1. A pedal grip pad configured for releasably receiving projections extending downwardly from a sole of a user's shoe, the pedal grip pad comprising:
a bottom surface configured for engagement with one of the two shoe-receiving faces of a pedal; and,
a platform for engaging the user's shoe, the platform comprising a planar top surface for receiving the sole of the user's shoe and a plurality of recesses that are equispaced from one another and distributed throughout the top surface of the platform, wherein the each recess of the plurality of recesses extends downwardly from the top surface, and is shaped and sized to receive a respective projection of the user's shoe.

2. The pedal grip pad of claim 1, wherein each recess of the plurality of recesses comprises a floor at a depth between the top surface of the platform and the bottom surface of the pedal grip pad.

3. The pedal grip pad of claim 2, wherein each respective floor of each recess lies in a plane that defines an intermediate surface configured to engage respective ends of the projections when the projections are inserted into the plurality of recesses.

4. The pedal grip pad of claim 1, wherein each recess comprises one or more sidewalls configured to engage against a length of a respective projection of the user's shoe.

5. The pedal grip pad of claim 1, wherein the plurality of recesses are generally distributed in a waffle pattern.

6. The pedal grip pad of claim 1, wherein the pedal grip pad is provided in a kit as a pair of pedal grip pads and a pedal, where the pair of pedal grip pads are securable to the pedal.

7. A pedal comprising platforms for receiving a user's shoe having projections extending downwardly from a sole thereof, each platform comprising:
a planar top surface for receiving the sole of the user's shoe; and a plurality of recesses, wherein each recess is equispaced from one another and distributed throughout the top surface of the platform, the plurality of recesses extending downwardly from the top surface and being shaped and sized to receive a respective projection of the user's shoe.

8. The pedal of claim 7, wherein each recess comprises a floor at a depth below the top surface of the platform, the respective floors of each recess lying in a plane that defines an intermediate surface configured to engage respective ends of the projections when the projections are inserted into the plurality of recesses.

9. The pedal of claim 7, wherein each recess comprises one or more sidewalls configured to engage against a length of a respective projection of the user's shoe.

10. The pedal of claim 7, wherein the plurality of recesses are generally distributed in a waffle pattern.

11. A pedal and shoe system comprising:
a shoe having a sole, the shoe comprising a plurality of projections extending downwardly from the sole;
a pedal platform having a planar top surface for receiving the sole and a plurality of recesses, wherein each recess is equispaced from one another and distributed throughout the top surface of the pedal platform; and,
the plurality of recesses extending downwardly from the planer top surface and being shaped and sized to removably receive the plurality of projections.

12. The pedal and shoe system of claim 11, wherein the plurality of projections comprise rigid spikes.

13. The pedal and shoe system of claim 11, wherein the projections are evenly distributed across the sole of the shoe.
